(19) United States
(12) Patent Application Publication
(10) Pub. No.: US 2013/0007411 A1
(43) Pub. Date: Jan. 3, 2013

(54) Configurable Allocation of Hardware Resources

(75) Inventors: Michael Asa, Kfar Saba (IL); Guy Caspary, Haifa (IL)

(73) Assignee: BROADCOM CORPORATION, Irvine, CA (US)

(21) Appl. No.: 13/171,740

(22) Filed: Jun. 29, 2011

(51) Int. Cl. G06F 15/76; G06F 9/02

(52) U.S. Cl. 712/29; 712/E09.002

(57) ABSTRACT

Disclosed are various embodiments of configurable allocation of hardware resources. In one embodiment, a processing device includes a configurable communication grid including a plurality of crossbars interconnected by intercommunication paths in a geometric configuration and a plurality of pipeline elements distributed within the configurable communication grid. Each crossbar is designed to direct communications received at an input to a selected output. Each pipeline element is communicatively coupled to an output of a first crossbar adjacent to the pipeline element and an input of a second crossbar adjacent to the pipeline element. In another embodiment, a process matrix includes a plurality of pipeline elements interconnected by a configurable communication grid. The configurable communication grid includes intercommunication paths connecting crossbars in a geometric configuration. The crossbars are configured to implement at least a portion of a hardware pipeline by directing communications between at least a portion of the pipeline elements.

### BACKGROUND

Many devices utilize hardware pipelines for processing data in an assembly line fashion. The pipeline is divided up into stages such as instruction decoding, arithmetic, and register fetching stages. Each pipeline consists of a sequence of pipeline elements or resources that perform a series of defined tasks to produce the desired result. The processing elements are defined in a desired sequence during design and fixed in position during implementation of the device.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a drawing of an example of a hardware pipeline in accordance with various embodiments of the present disclosure;

FIG. 2 is a drawing of an example of a generalized loop based upon the hardware pipeline of FIG. 1 in accordance with various embodiments of the present disclosure;

FIG. 3 is a drawing of an example of a process matrix used to implement the hardware pipeline of FIG. 1 in accordance with various embodiments of the present disclosure;

FIG. 4 is a drawing of an example of a crossbar of the process matrix of FIG. 3 in accordance with various embodiments of the present disclosure; and

FIG. 5 is a drawing of the process matrix of FIG. 3 illustrating an example of the implementation of the hardware pipeline of FIG. 1 in accordance with various embodiments of the present disclosure.

FIG. 6 is a drawing of the process matrix of FIG. 3 illustrating an example of the implementation of a plurality of hardware pipelines in accordance with various embodiments of the present disclosure.

FIG. 7 is a flow chart illustrating the configuration or reconfiguration of a process matrix of FIG. 3 in accordance with various embodiments of the present disclosure.

### DETAILED DESCRIPTION

A pipeline includes a series of simplified tasks that when performed in sequence produces a desired result. The tasks are performed by pipeline elements or stages of pipeline elements with each pipeline element taking an input and producing an output that may be supplied as an input to the next pipeline element in the series. This arrangement allows the stages to work in parallel and thus provides greater throughput capacity. Many processing devices (e.g., central processing units (CPU) or other application specific devices or chips) are arranged with one or more pipelines with different stages performing a variety of tasks.

A hardware pipeline should include sufficient processing resources in order to handle the worst case scenario in every stage of the pipeline. If the same hardware implementation is used for several applications such as packet routing, classification, etc., then the pipeline structure should be designed to handle the sum of all processing capabilities. Such a pipeline contains more pipeline elements than those needed by any single application, and is therefore larger in area and latency.

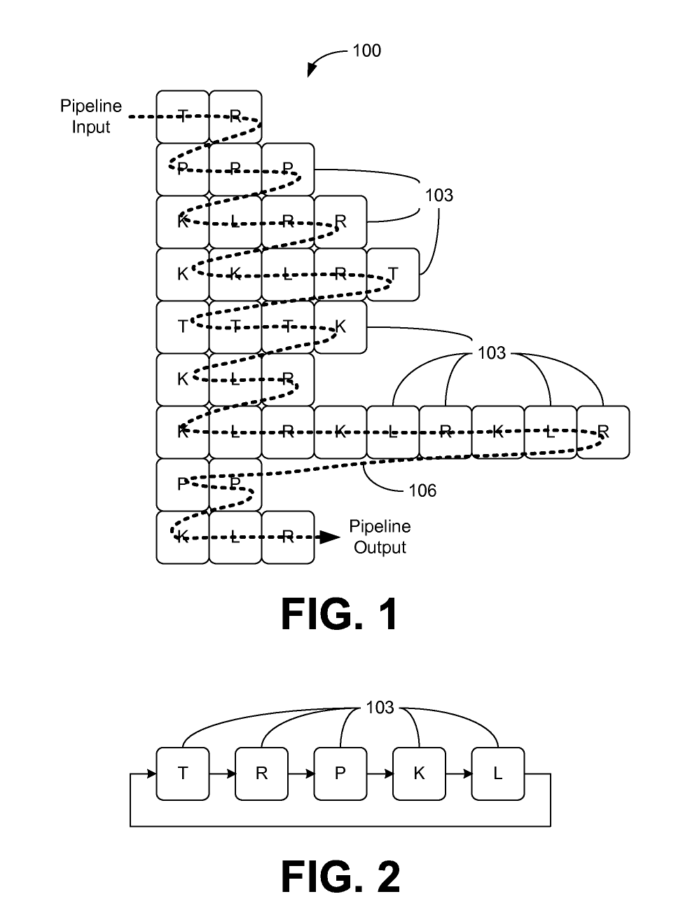

With reference to FIG. 1, shown is a graphical representation of an example of a hardware pipeline 100. The pipeline implementation of FIG. 1 uses a plurality of pipeline elements 103 to produce the desired processing result. The pipeline elements 103 are designed to perform a function that, when implemented in sequence, produces the desired result. One or more type(s) of pipeline elements 103 may be used in a hardware pipeline. In the example of FIG. 1, five basic pipeline elements 103 are utilized in the hardware pipeline 103, with each element 103 designated as one of T, R, P, K, or L based upon their functionality. Examples of functions that may be performed by the basic pipeline elements 103 may include, but are not limited to, instruction fetch, instruction decode, memory access, execute, register write, etc.

Other pipeline designs may be implemented using the same basic pipeline elements 103 in a different order or combination to yield a different result. In other designs, a different set of basic pipeline elements 103, which may include none, some, or all of the five elements of FIG. 1, may be used to implement a hardware pipeline. In addition, one or more specialized element(s) may be used in a hardware pipeline 100 to obtain the desired result. A specialized element is designed to perform a specific function during the pipeline process.

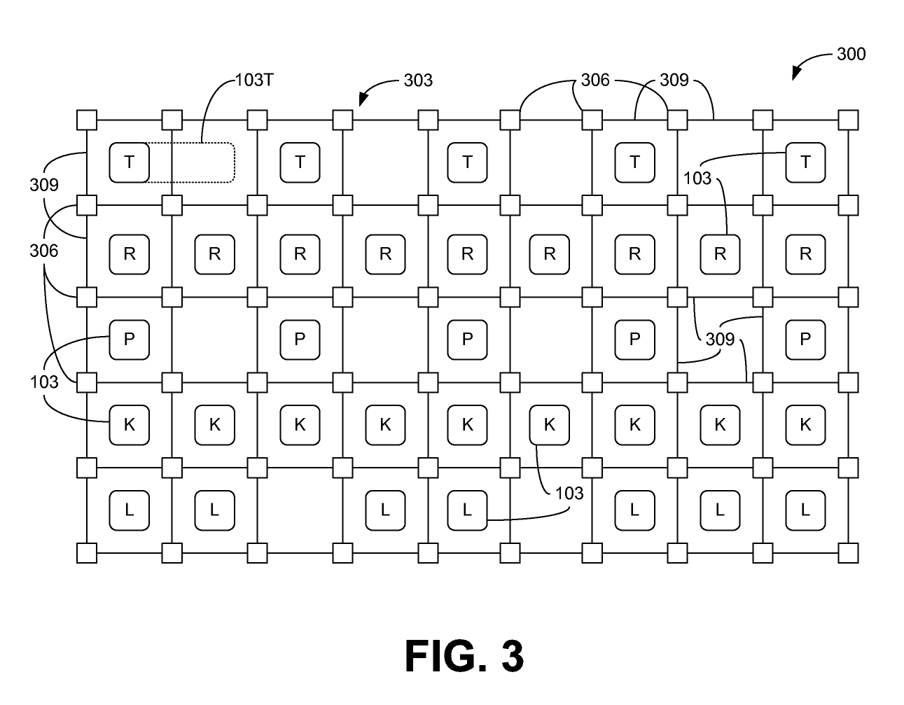

The processing flow 106 through the hardware pipeline 100 is determined during design of the pipeline and the processing device. The pipeline 100 may then be generalized as a loop of pipeline elements 103. For example, the hardware pipeline 100 of FIG. 1 may be generalized as a loop 200 including the five basic pipeline elements 103 (T, R, P, K, and L) as illustrated in FIG. 2. A process matrix including the pipeline elements of the generalized loop 200 may then be developed based upon the requirements of the hardware pipeline 100 (FIG. 1).

Referring to FIG. 3, shown is an example of a process matrix 300 for the pipeline elements 103 of the example hardware pipeline 100 of FIG. 1. The process matrix 300 includes the pipeline elements 103 needed to implement the hardware pipeline 100. The process matrix 300 also includes a configurable communication grid 303 for interconnecting the pipeline elements 103. The configurable communication grid 303 includes crossbars 306 (e.g., configurable routing devices) in communication with a plurality of intercommunication paths 309 and adjacent pipeline elements 103. The configurable communication grid 303 may be provided in a geometric configuration such as a rectangular configuration, as depicted in FIG. 3, or other geometric configuration (e.g., a hexagon or triangular configuration with crossbars 306 at some or all of the intersecting points) as appropriate.

In the embodiment of FIG. 3, each row of pipeline elements 103 in the process matrix 300 includes the same type (T, R, P, K, and L) of pipeline element 103. Placement of the pipeline elements 103 with respect to the geometric communication grid 303 is determined by design based upon the requirements of the hardware pipeline 100, as well as other considerations such as latency of the pipeline flow, size (or footprint) of each type of pipeline element 103, heating considerations, etc. For example, the footprint of a T-type pipeline element (e.g., pipeline element 103T) may be larger than the spacing between crossbars 306 and/or intercommunication paths 309. The pipeline element 103T may then be designed to extend over (or under) one or more adjacent intercommunication path(s) 309 and/or crossbar(s) 306. In other embodiments, the pipeline element 103T may be implemented as two pipeline elements with smaller footprints that do not extend over (or under) adjacent intercommunication path(s) 309 and/or crossbar(s) 306 and that are connected in series through crossbar(s) 306 and/or intercommunication path(s) 309.

In the example of FIG. 3, the pipeline element type in each row is consistent with the ordering of the generalized loop 200 of FIG. 2 (i.e., T in first row, R in second row, etc.). However, in some embodiments, different types of pipeline elements 103 may be included in the same row. A hardware pipeline 100 may also require one or more specialized element(s) to perform a specific function in addition to the basic pipeline elements 103. The specialized element(s) may be placed in a central location in the process matrix 300 or may be located in another location based upon the sequencing of the hardware pipeline 100. For example, if the specialized element is utilized at the beginning (or the end) of the pipeline process, then the specialized element may be placed along an edge of the process matrix 300.

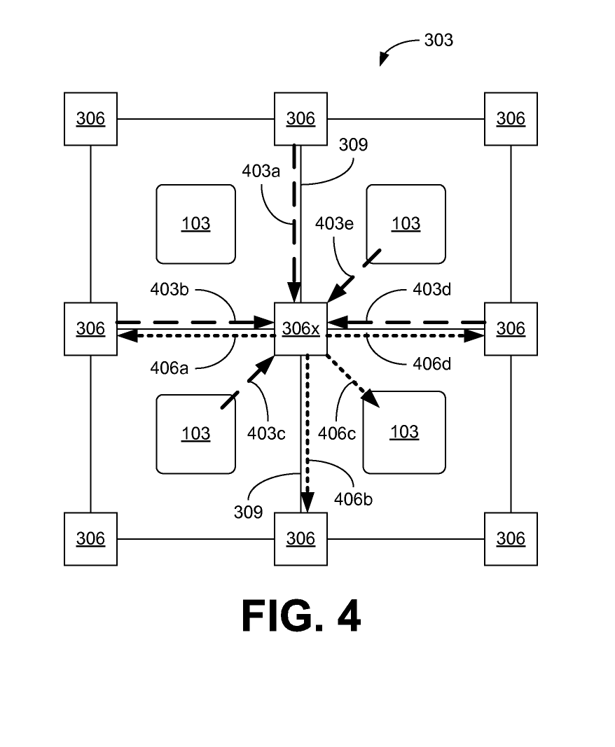

A crossbar 306 is a configurable routing device including, e.g., a plurality of multiplexers (MUX), de-multiplexers, or other appropriate switching device for directing communication traffic between pipeline elements 103 and/or crossbars 306. Referring to FIG. 4, shown is a portion of a process matrix 300 including a crossbar 306. A crossbar 306 is in communication with one or more adjacent pipeline element(s) 103 and with adjacent crossbars 306 through intercommunication paths 309. The crossbar 306 accepts a signal or data from a pipeline element 103 or intercommunication path 309 through an input 403 and directs the signal to the appropriate pipeline element 103 or intercommunication path 309 through an output 406. In some embodiments, the crossbar 306 includes inputs 403 and outputs 406 to all adjacent pipeline elements 103 and all adjacent intercommunication paths 309. A MUX (or other switching device) is used to direct the signal from the corresponding input 403 to one of the plurality of outputs 406. In other embodiments, the crossbar 306 may be designed to direct signals from only a portion of the inputs 403 to a portion of the outputs 406. For example, the number of MUX may be equal to the number of active outputs 406. Limiting the number of inputs 403 and outputs 406 reduces the size and complexity of the implemented crossbars 306.

FIG. 4 shows a portion of a process matrix 300 to illustrate examples of communication paths through an example of a crossbar 306x in a portion of the configurable communication grid 303 (FIG. 3). In the embodiment of FIG. 4, the crossbar 306x accepts signals through predefined inputs and directs the input signals to one of the outputs. In FIG. 4, the crossbar 306x is designed to accept signals through inputs 403 from three of the four intercommunication paths 309 (inputs 403a, 403b, and 403d) and from two of the four possible pipeline elements 103 (inputs 403c and 403e) and to direct the signals through outputs 406 to three of the four intercommunication paths 309 (outputs 406a, 406b, and 406d) or to one of the four possible pipeline elements 103 (output 406c). Other numbers and combinations of predefined inputs 403 and outputs 406 may be utilized as can be understood.

The signals are directed between an input 403 and an output 406 of a crossbar 306x by a MUX, or other appropriate switching device. Each MUX or other switching device of the crossbar 306x may be individually configured to direct the signal routing between an input 403 and an output 406. Configuration of the crossbars 306 in the configurable communication grid 303 may be accomplished using a secondary control or communication circuit. Addressing and/or other appropriate control signals may be used to define the position of each MUX during setup of the crossbars 306. Once the setup is complete, a signal received from an input 403 is automatically directed by the MUX to the appropriate output 406.

In the embodiment of FIG. 4, the crossbar 306x would include four MUX with each corresponding to a different one of the four outputs 406. In this example, each MUX is a 5-to-1 MUX. Each MUX directs a signal from one of the five possible inputs 403 to the corresponding output 406. The output 403 is defined during the configuration or setup of the crossbar 306x. For example, the crossbar 306x may be configured to direct all signals received from input 403a to output 406c. Similarly, the crossbar 306x may also be configured to direct all signals received from input 403c to output 406d.

Configuration of the crossbars 306 may be accomplished using a secondary control or communication circuit during setup of the process matrix 300 to implement a hardware pipeline. The secondary circuit may also be used to reconfigure one or more crossbar(s) 306 to modify an existing pipeline or to implement a different pipeline. For example, the crossbar 306 discussed above may be reconfigured to direct all signals received from input 403a to output 406b instead of output 406c. The ability to reconfigure the process matrix 300 allows a single processing device to be utilized for the implementation of a variety of pipelines or for the modification of an existing pipeline without the need to replace the processing device.

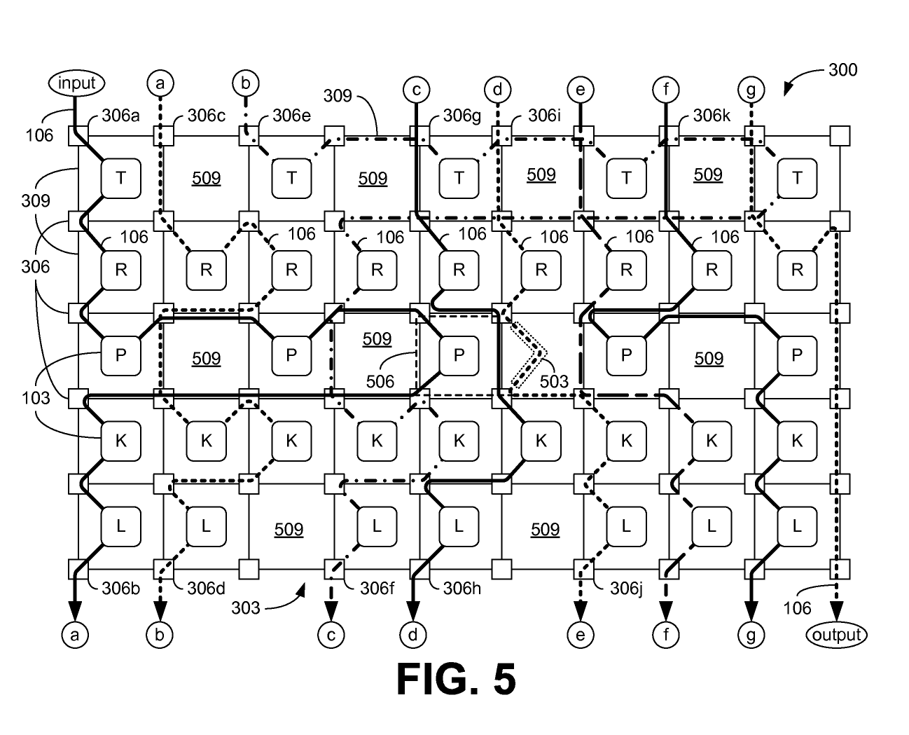

Referring now to FIG. 5, shown is an implementation of the hardware pipeline 100 of FIG. 1 using the process matrix 300 of FIG. 3. In the example of FIG. 5, the pipeline input is provided through the crossbar 306a in the upper left corner of the configurable communication grid 303. During setup of the hardware pipeline 100, the crossbar 306a has been configured to direct a signal from input 403a (FIG. 4) to the first pipeline element 103 through output 406c (FIG. 4). The pipeline element 103 performs its designed function and sends the resulting signal to the next pipeline element 103 based upon the configuration of the crossbar(s) 306. The processing flow 106 (FIG. 1) continues through the configurable communication grid 303 and the first seven pipeline elements 103 (T, R, P, P, P, K, L) before reaching crossbar 306b in the bottom row of the configurable communication grid 303. As can be seen in FIG. 5, the processing flow 106 is allowed to progress in both vertical and horizontal directions within the process matrix 300.

Crossbar 306b has been configured to direct the signal from input 403e (FIG. 4) to output 406b (FIG. 4), which is sent to crossbar 406c in the top row of the configurable communication grid 303. In some embodiments, the output 406b of crossbar 306b is directly connected to the input 403a (FIG. 4) of crossbar 406c or to an output of the process matrix 300. In other embodiments, the output 406b of crossbar 306b is connected to a MUX or other appropriate switching device that may direct the output signal to one or more of the crossbars 306 in the top row of the configurable communication grid 303 or to an output of the process matrix 300. The setting of the MUX may be accomplished using the secondary control or communication circuit during the setup or modification of the process matrix 300. The output 406b of some or all of the remaining crossbars 306 in the in the bottom row of the configurable communication grid 303 may be similarly connected to one or more of the crossbars 306 in the top row of the configurable communication grid 303 or to an output of the process matrix 300. In some embodiments, the output of a crossbar 306 along the outer edges (e.g., top, bottom and sides of FIG. 3) of the configurable communication grid 303 may be directed to an input of another crossbar 306 along the outer edges of the configurable communication grid 303 (e.g., using outputs 406a or 406d and inputs 403b and 403d of a crossbar (FIG. 4) in the side columns).

Crossbar 306c has been configured to direct the signal from input 403a (FIG. 4) to output 406b (FIG. 4). The processing flow 106 continues through the configurable communication grid 303 and the next five pipeline elements 103 (R, R, K, K, L) before reaching crossbar 306d in the bottom row of the configurable communication grid 303. The processing flow 106 is directed to crossbar 306e in the top row of the configurable communication grid 303 where it is again directed through the configurable communication grid 303 and the next eight pipeline elements 103 (T, T, T, T, R, K, K, L). Crossbar 306f sends the processing flow 106 to crossbar 306g and through the configurable communication grid 303 and the next three pipeline elements 103 (R, K, L) where crossbar 306h sends it to crossbar 306i.

From crossbar 306i, the processing flow 106 continues through an R-type pipeline element 103, a bypass connection 503, and K-type and L-type pipeline elements to crossbar 306j. The process matrix 300 may include one or more bypass connections 503 in place of a pipeline element 103. While a bypass interconnection 503 may reduce latency, other paths through the configurable communication grid 303 may be utilized. For example, instead of passing through the bypass interconnection 503, the processing flow 106 may be directed around the P-type pipeline element along path 506.

From crossbar 306j, the processing flow 106 passes through crossbar 30k and continues through the configurable communication grid 303 and the remaining pipeline elements 103 of the hardware pipeline 100 (FIG. 1). After passing through each of the pipeline elements, the pipeline output is directed out of the process matrix 300 at the lower right corner of FIG. 5.

The processing capability of a certain path through the process matrix 300 is achieved by configuring the crossbars 306 to divert the processing flow 106 through the pipeline elements 103 of the process matrix 300. The ability to reconfigure the processing flow 106 through the process matrix 300 makes the implementation very flexible for implementing a wide variety of hardware pipelines.

This flexibility allows the movement of pipeline elements 103 within a pipeline according to the specific requirements of an application. For example, if only a portion of the hardware pipeline 100 of FIG. 1 was needed to perform a desired function, then the crossbars 306 may be reconfigured to use only that portion of the hardware pipeline 100 to provide the output. The process matrix 300 may be reconfigured if the full hardware pipeline 100 is needed at a later time.

In addition, if only a portion of the process matrix 300 is used to implement a hardware pipeline, then the process matrix 300 may be configured to implement a plurality of hardware pipelines in parallel. For example, the left half of the process matrix 300 may be configured to implement a first hardware pipeline and the right half of the process matrix 300 may be configured to implement a second hardware pipeline. In other embodiments, the first and second hardware pipelines may share one or more crossbar(s) 306 and/or intercommunication path(s) 309.

Additional pipeline elements 103 may also be included within the unused portions 509 of the process matrix 300. These pipeline elements 103 are in addition to those needed to implement the hardware pipeline 100 of FIG. 1. The type and number of additional pipeline elements 103 may be determined during design based upon common usage and/or anticipated needs. The additional pipeline elements 103 provide the ability to use the process matrix 300 to implement pipeline configurations that have not been considered when the processing device is being produced. For example, the inclusion of additional pipeline elements 103 may allow the implementation of an additional stage in the hardware pipeline 100 without the replacement of the processing device.

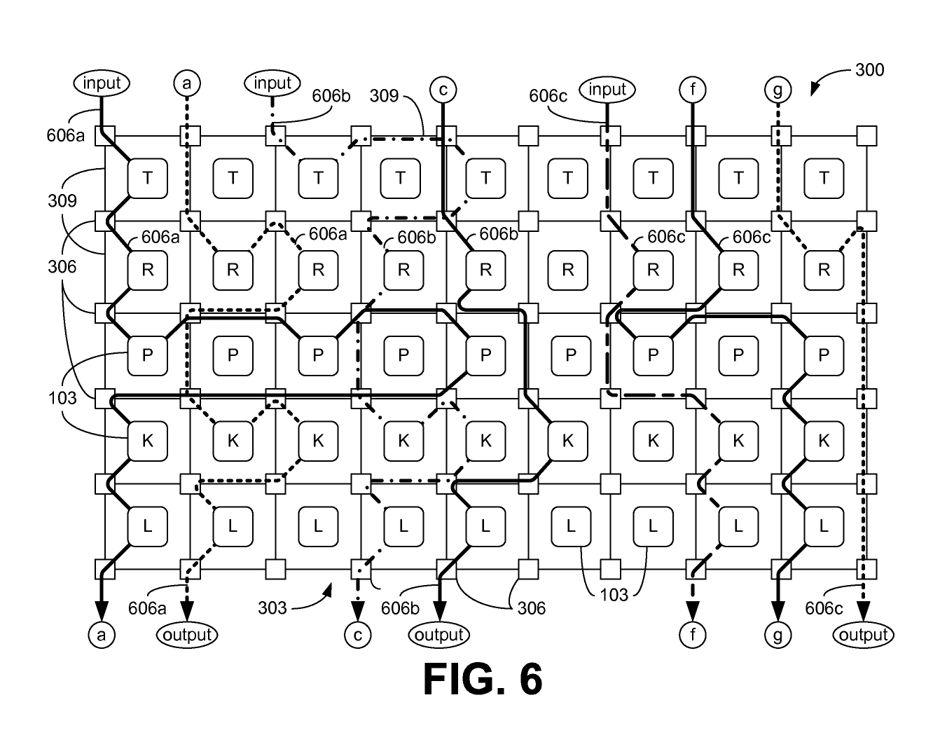

Referring to FIG. 6, shown is a process matrix 300 illustrating an example of the implementation of a plurality of hardware pipelines. A first processing flow 606a on the left side of the process matrix 300 corresponds to the implementation of a first hardware pipeline, a second processing flow 606b in the center of the process matrix 300 corresponds to the implementation of a second hardware pipeline, and a third processing flow 606c on the right side of the process matrix 300 corresponds to the implementation of a third hardware pipeline. As can be seen in the example of FIG. 6, the first and second processing flows 606a and 606b overlap while the third processing flow 606c is isolated from the other two processing flows 606a and 606b. In addition, additional pipeline elements 103 are included within the unused portions 509 (FIG. 5) of the process matrix 300.

Unused pipeline elements 103 may be deactivated or shutdown to reduce power consumption of the process matrix 300. If multiple redundant hardware pipelines are implemented by the process matrix 300, one or more of the hardware pipelines may be shutdown to reduce power consumption in response to predefined limits with respect to processing requirements. The deactivation of unused pipeline elements 103 may be controlled through the secondary control or communication circuit during configuration of the hardware pipeline. In some embodiments, a separate control unit may deactivate or activate pipeline elements 103 in response to the processing requirements.

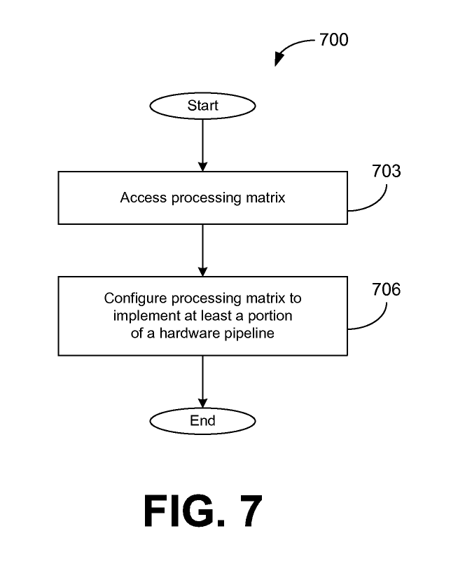

Referring to FIG. 7, shown is a flow chart or diagram 700 illustrating the configuration or reconfiguration of a process matrix 300 (FIGS. 3 and 5). Beginning with block 703, the process matrix 300 including a configurable communication grid 303 is accessed. The process matrix 300 may be accessed through a secondary control or communication channel in communication with the crossbars 306. The pipeline elements 103 may also be accessed through the secondary control channel. The process matrix 300 may already be configured to implement at least a portion of a hardware pipeline 100 (FIG. 1). As illustrate by the example of FIG. 5, a plurality of crossbars 306 has been configured to direct communications between a series of pipeline elements 103 to implement the hardware pipeline 100. In some implementations, pipeline elements 103 that are not used to implement the hardware pipeline have been deactivated to reduce power consumption.

In block 706, the configurable communication grid 303 is to implement at least a portion of a hardware pipeline by configuring the crossbars to direct communications between a series of pipeline elements 103. The configurable communication grid 303 may also be reconfigured in block 706 to implement another hardware pipeline through a different series of pipeline elements 103. The second hardware pipeline may be a modification of a first hardware series or may be a new hardware pipeline including none, some, or all of the pipeline elements 103 of the first series. Unused pipeline elements 103 may be deactivated to reduce power consumption. In addition, deactivated pipeline elements 103 that are included in the configured or reconfigured pipeline are activated. A plurality of hardware pipelines or portions of hardware pipelines may be configured or reconfigured in block 706.

It should be emphasized that the above-described embodiments of the present invention are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A processing device, comprising:
a configurable communication grid including a plurality of crossbars interconnected by a plurality of intercommunication paths in a geometric configuration, each crossbar designed to direct communications received at one of a plurality of inputs to a selected one of a plurality of outputs; and
a plurality of pipeline elements distributed within the configurable communication grid, the plurality of pipeline elements including a plurality of types of pipeline elements, each pipeline element communicatively coupled to an output of a first crossbar adjacent to the pipeline element and communicatively coupled to an input of a second crossbar adjacent to the pipeline element.

2. The processing device of claim 1, wherein each crossbar includes a plurality of configurable switching devices, each configurable switching device designed to direct a communication received at a corresponding input to the selected output.

3. The processing device of claim 2, wherein the configurable switching devices include multiplexers (MUX).

4. The processing device of claim 1, wherein the plurality of outputs include a connection to an adjacent pipeline element and at least one connection to an intercommunication path.

5. The processing device of claim 4, wherein the plurality of outputs include a plurality of connections to corresponding intercommunication paths.

6. The processing device of claim 1, wherein the plurality of inputs include a connection to an adjacent pipeline element and at least one connection to an intercommunication path.

7. The processing device of claim 1, further comprising a secondary control circuit in communication with the plurality of crossbars.

8. The processing device of claim 7, wherein the selected output is configured through the secondary control circuit.

9. The processing device of claim 1, wherein the selected outputs of at least a portion of the plurality of crossbars are configured to implement a hardware pipeline by directing communications between at least a portion of the plurality of pipeline elements.

10. The processing device of claim 9, wherein the selected outputs of another portion of the plurality of crossbars are configured to implement a second hardware pipeline by directing communications between another portion of the plurality of pipeline elements.

11. The processing device of claim 9, wherein at least one pipeline element not used to implement the hardware pipeline is deactivated.

12. A process matrix, comprising:
a configurable communication grid including:
a plurality of crossbars; and
a plurality of intercommunication paths connecting the crossbars in a geometric configuration; and
a plurality of pipeline elements interconnected by the configurable communication grid, the plurality of pipeline elements including a plurality of types of pipeline elements, where the plurality of crossbars are configured to implement at least a portion of a hardware pipeline by directing communications between at least a portion of the plurality of pipeline elements.

13. The process matrix of claim 12, wherein the plurality of pipeline elements are distributed within the configurable communication grid and connected to adjacent crossbars of the configurable communication grid.

14. The process matrix of claim 13, wherein each of the plurality of crossbars is designed to direct a communication received at an input of the crossbar to one of a group of selectable outputs of the crossbar, the selectable outputs including at least one of the pipeline elements and at least one intercommunication path.

15. The process matrix of claim 14, wherein each crossbar includes a configurable switching device that directs the received communication to the selected output.

16. The process matrix of claim 12, wherein the plurality pipeline elements includes pipeline elements of different sizes.

17. The process matrix of claim 12, wherein a portion of the process matrix between a plurality of adjacent crossbars of the configurable communication grid is unused.

18. A method, comprising the steps of:
accessing a process matrix including a configurable communication grid communicatively coupled with a plurality of pipeline elements, the configurable communication grid configured to implement at least a portion of a hardware pipeline through a series of the pipeline elements; and
reconfiguring the configurable communication grid to implement at least a portion of a second hardware pipeline through a different series of the pipeline elements.

19. The method of claim 18, wherein the second hardware pipeline is a modification of the first hardware pipeline.

20. The method of claim 18, further comprising deactivating a pipeline element included in the first hardware pipeline and not included in the second hardware pipeline.
